(19) United States
(12) Patent Application Publication
(10) Pub. No.: US 2024/0158021 A1
(43) Pub. Date: May 16, 2024

(54) Body Part, Vehicle, Semi-Finished Product and Method for Producing a Body Part

(71) Applicant: Bayerische Motoren Werke Aktiengesellschaft, Muenchen (DE)

(72) Inventors: Michael BECHTOLD, Landshut (DE); Josef BICHLMEIER, Dorfen (DE)

(21) Appl. No.: 18/281,620

(22) PCT Filed: Feb. 25, 2022
(86) PCT No.: PCT/EP2022/054740

§ 371 Date: Sep. 12, 2023

(30) Foreign Application Priority Data
Mar. 23, 2021 (DE) 10 2021 107 096.1

(51) Int. Cl. B62D 29/04; B29C 33/38; B29C 43/56; B29C 70/08; B29L 31/30; B62D 25/06

(52) U.S. Cl. CPC B62D 29/043; B29C 33/3807; B29C 70/08; B62D 25/06; B29C 2043/567; B29K 2995/0011; B29L 2031/3055; B60Y 2200/11

(57) ABSTRACT

A bodywork component for a vehicle includes a base element and a transmission element. The base element has fiber-reinforced plastic with base fibers. The transmission element has fiber-reinforced plastic with transmission fibers. The transmission fibers are configured to enable radio signal communication through the transmission element, and have a higher radio signal transmissibility than the base fibers.

### BACKGROUND

The present disclosure relates to a bodywork component of fiber-reinforced plastic for a vehicle. The disclosure further relates to a semifinished product for producing such a bodywork component, to a vehicle having such a bodywork component, and to a method for producing such a bodywork component.

Bodywork components for vehicles are subject to numerous requirements. The main requirements have over many years included in particular a minimal weight and a maximal stability. These mechanical requirements, between which sometimes a compromise has to be found, have been joined over the past years to an ever-increasing extent by signal-related requirements. These include in particular a certain radio signal transmissibility of the bodywork component, so that, for example, there is minimal adverse effect on radio reception or signal reception by a wireless telephone in the vehicle. In order consistently to provide the desired signal communication between a vehicle interior and the vehicle surroundings, bodywork components such as vehicle roofs have been developed with roof joints whose reduced physical thickness and alternative physical constitution in comparison to the rest of the vehicle roof allow improved signal communication to be achieved. There are roof antennas via which radio signals can be passed into the vehicle from the vehicle surroundings and also sent from the vehicle into the vehicle surroundings.

### SUMMARY

It is an object of the present disclosure to take at least partial account of the problems described above. An object of the present disclosure more particularly is to provide an improved bodywork component which combines minimal weight and high stability with sufficiently high radio signal transmissibility.

The above object is achieved by the bodywork component, the semifinished product, the vehicle, and the method disclosed herein. Further advantages are evident from the description, and the figures. Here, features that are described in connection with the bodywork component are of course also valid in connection with the semifinished product of the disclosure, the vehicle of the disclosure, the method of the disclosure, and vice versa in each case, and so mutual reference is and/or may be made always with regard to the disclosure in relation to the individual disclosure aspects.

According to a first aspect of the present disclosure, a bodywork component for a vehicle is provided. The bodywork component comprises a base element of fiber-reinforced plastic with base fibers, and a transmission element of fiber-reinforced plastic with transmission fibers, where the transmission fibers, to enable radio signal communication through the transmission element, have a higher radio signal transmissibility than the base fibers.

Within the present disclosure it has been recognized that conventional fiber composite materials that are used to manufacture bodywork components differ, sometimes significantly, in their radio signal transmissibility with respect to radio signals. It has been discovered more particularly that bodywork components known in the prior art, such as vehicle roofs, made of carbon fiber-reinforced plastic with the customary component thickness have a strong or complete shielding effect on certain radio signals, such as 5G radio signals, for example. This means that a vehicle roof of this kind, if installed in a vehicle, would severely negatively impact the signal reception. Further tests have revealed that even relatively small portions of component featuring alternative fiber composite materials which have a higher radio signal transmissibility are sufficient to achieve the desired radio signal transmissibility for the whole bodywork component. Presently, therefore, it is possible to provide a weight-optimized and yet stable bodywork component made of fiber composite plastic that additionally allows high radio signal transmissibility with reference to a maximal bandwidth of radio signals. Through the use of fiber composite materials, the bodywork component may be designed with a smooth, continuous, planar and/or joint-free surface geometry. This promotes a streamlined design of the bodywork component and also of a vehicle comprising such a bodywork component. The base element and the transmission element are preferably bonded mechanically to one another. In particular, the base fibers and the transmission fibers may be at least partly woven with one another. A fiber composite between the base element and the transmission element provides a particularly stable and fluid-tight material bond. Problems with leakage, bonding and/or stability, as are known in conventional deployments in metal components and simple plastic components, can therefore be prevented.

The base element and/or the transmission element preferably each have a continuously solid structure. In particular, the transmission element has no transmission opening and/or fluid passages. Accordingly, the base element and/or the transmission element may each be referred to as a closed structure. In terms of volume and/or weight, base element and transmission element preferably form the main constituent of the bodywork component. More particularly, in terms of volume and/or weight, base element and transmission element form more than 80% or more than 90% of the bodywork component. The base element may be understood as a load-bearing base element and/or as the load-bearing constituent of the bodywork component. Accordingly, the base element may comprise fastening portions for fastening the bodywork component in and/or on the vehicle. The bodywork component is preferably in sheet form, more particularly in curved sheet form, as for example in the form of what is called a sheet molding compound and/or using a corresponding process. Accordingly, by comparison with a bodywork component length and with a bodywork component width, the bodywork component has a bodywork component thickness or height which is smaller by a multiple. The bodywork component or bodywork material thickness is, for example, in a range between 0.5 mm and 3 mm, more particularly in a range between 1.5 mm and 2.5 mm.

The radio signal transmissibility refers in particular to a transmissiveness and/or a degree of shielding in respect of various radio signals. A material having a high radio signal transmissibility shields radio signals less strongly than a material having a low radio signal transmissibility. To enable the desired radio signal communication, the transmission element has a physical thickness with which it is still possible to achieve a predefined signal transmissibility for certain radio signals such as a 5G radio signal. The bodywork component preferably has a consistent and/or continuous bodywork component thickness. Fiber-reinforced plastic may be understood presently to comprise, in particular, a fiber-plastic composite and/or fiber composite plastic, comprising a matrix of plastic and also reinforcing fibers, presently in the form of the transmission fibers and the base fibers. The plastic matrix surrounds the reinforcing fibers, which are bonded to the plastic matrix by adhesive interactions. The fiber-reinforced plastic of the base element preferably has a higher stability and/or strength than the fiber-reinforced plastic of the transmission element. Moreover, the fiber-reinforced plastic of the base element may have a lower specific weight than the fiber-reinforced plastic of the transmission element. The plastic matrix may take the form of a thermoset plastic matrix, a thermoplastic matrix, an elastomeric plastic matrix and/or a corresponding resin.

It is additionally possible for the bodywork component to comprise an outer element composed of outer fiber-reinforced plastic with outer fibers, where the outer element covers the base element and the transmission element and forms an exterior of the bodywork component, and where the outer fibers, to enable radio signal communication through the outer element, have a higher radio signal transmissibility than the base fibers. Through the outer element it is possible to improve the stability of the bodywork component in combination with radio signal transmissibility. While the transmission element is designed, for example, in glass fiber-reinforced plastic or as a GRP transmission element, the outer element may likewise be designed in glass fiber-reinforced plastic or, preferably, in basalt fiber-reinforced plastic or as a BRP outer element. Basalt fibers lead to even greater stability than glass fibers and in the customary thickness of an outer element of the disclosure, in a range, for example, of less than 1 mm, more particularly in a range between 0.1 mm and 0.5 mm, nonetheless still have the desired radio signal transmissibility. Together, the base element, the transmission element, and the outer element form the main constituents and preferably the sole constituents of the proposed bodywork component.

According to a further embodiment of the present disclosure, it is possible for the base element, in the context of a bodywork component, to consist of carbon fiber-reinforced plastic and/or for the base fibers to be carbon fibers. Accordingly, the bodywork component may be realized with particularly high stability and at the same time relatively low weight. The base element preferably consists entirely of carbon fiber-reinforced plastic. The base element of carbon fiber-reinforced plastic may be understood as a CRP base element.

Further, it is possible that, in the context of a bodywork component according to the present disclosure, the transmission element consists of glass fiber-reinforced plastic, of aramid fiber-reinforced plastic and/or of basalt fiber-reinforced plastic and/or that the transmission fibers are glass fibers, aramid fibers and/or basalt fibers. In the course of tests in the context of the present disclosure it was recognized that glass fibers, aramid fibers and basalt fibers, even with a thickness customary for bodywork components, have the desired radio signal transmissibility and nonetheless fulfil the desired function in terms of stability and weight. The transmission element preferably consists entirely of the transmission fiber-reinforced plastic. The transmission element may be understood accordingly to be a GRP transmission element, a BRP transmission element or an ARP transmission element.

In one advantageous development of a bodywork component of the disclosure, the base element and the transmission element are in a substance-to-substance bond with one another. The substance-to-substance bond is produced more particularly by the respective plastic matrix of the base element and of the transmission element. It is possible accordingly to provide a fluid-tight, stable and correspondingly long-lived bond between the base element and the transmission element.

It is possible, moreover, in a bodywork component of the disclosure, for the base element to extend at least approximately over the entire bodywork component length or at least approximately over the entire bodywork component width of the bodywork component and/or for the transmission element to extend at least approximately over the entire bodywork component length or at least approximately over the entire bodywork component width of the bodywork component. Hence it is possible not only to effectively realize the desired functions in terms of radio signal transmissibility and stability, but also to make the manufacture of the bodywork component efficient. In this case, in particular, product in tape and/or roll form, for example, may be provided, from which the bodywork component can be rapidly and simply produced—cut to shape, for example. The idea that the base element and/or the transmission element each extend at least approximately over the entire bodywork component length or the entire bodywork component width may be understood to mean that the base element and/or the transmission element extend in each case over at least 80%, more particularly over at least 90%, of the entire bodywork component length or the entire bodywork component width. It is further possible for the base element to be designed in the form of a frame around the transmission element. A surrounding CRP frame allows a particularly stable bodywork component to be provided. It is possible, furthermore, for the transmission element to comprise a plurality of transmission regions which are designed with spacing from one another, and for the base element to be designed in the form of a frame around the transmission regions, with each transmission region being in possession, analogously, of the features and functions described for the transmission element. The base element may in this case comprise a kind of lattice structure which contributes effectively to the stability of the bodywork component.

A bodywork component of the disclosure may further have a bodywork component thickness, a bodywork component length and a bodywork component width, with the transmission element extending over the entire bodywork component thickness or at least approximately over the entire bodywork component thickness. Accordingly, the desired radio signal communication can be ensured or the desired radio signal transmissibility achieved. The idea that the transmission element extends at least approximately over the entire bodywork component thickness may be understood to mean that the transmission element extends over at least 80%, more particularly over at least 90%, of the entire bodywork component thickness. Here, the bodywork component is considered as a self-standing component. In the event of the bodywork component being provided in the form of a vehicle roof, for example, any inner roof lining added later in the vehicle construction is disregarded in terms of the bodywork component thickness.

According to a further design variant of the present disclosure, it is possible, in the context of a bodywork component, for the base element to have a base element volume and for the transmission element to have a transmission element volume, where the transmission element volume is in a range between 10% and 80% of the base element volume. Particularly in the case of bodywork components which consist predominantly or to an extent of more than 80% or 90%, for example, of the base element and the transmission element, it is possible, with such a ratio between base element and transmission element, to achieve the desired stability through the base element and also the desired radio signal transmissibility through the transmission element. Additionally, in tests on a bodywork component of the disclosure, it has emerged as being advantageous, in terms of the desired tradeoff between stability and radio signal transmissibility, that if the bodywork component has a total volume and the transmission element has a transmission element volume, the transmission element volume is in a range between 3% and 30%, more particularly in a range between 5% and 15%, of the total volume.

The above-described bodywork component is preferably configured and designed as a vehicle roof or for producing a vehicle roof. Vehicle roofs have a great influence, in vehicles, on the desired facility for radio signal communication from the vehicle and into the vehicle. With the proposed bodywork component, it is possible to provide a vehicle roof having the desired properties, more particularly having a combination of high stability and low weight and nevertheless sufficiently high radio signal transmissibility. As already mentioned above, the vehicle roof in this case should be considered without any additional inner roof lining.

According to a further aspect of the present disclosure, a semifinished product for producing a bodywork component as described above is provided. The semifinished product comprises a semifinished base element with base fibers and a semifinished transmission element with transmission fibers, where the transmission fibers, to enable radio signal communication through the transmission fibers, have a higher radio signal transmissibility than the base fibers. Accordingly, the semifinished product of the disclosure is attended by the same advantages as have been described comprehensively with reference to the bodywork component of the disclosure. The bodywork component may be produced by processes such as preforming, wet compression molding, autoclave fabrication, or rapid transfer molding, from the semifinished product. The semifinished product is more particularly a semifinished textile product, preferably a semifinished exclusively textile product. The base fibers and the transmission fibers of a semifinished product of the disclosure are preferably in a form-fitting and/or force-fitting bond with one another. More particularly, the base fibers and the transmission fibers are at least partly woven with one another and/or braided with one another. A semifinished product of this kind may be provided as a roll product and hence provided for particularly simple, rapid and, correspondingly, cost-effective onward processing.

A further aspect of the present disclosure concerns a vehicle having a bodywork component as described above. Accordingly, the vehicle of the disclosure is also attended by the advantages described above. The vehicle is more particularly a vehicle for passengers such as an automobile, a truck, a passenger aircraft, a passenger rail vehicle, a passenger watercraft, or a passenger robot, i.e., a corresponding vehicle or conveyance for carrying passengers. A vehicle of the disclosure preferably comprises a vehicle roof which comprises the bodywork component or is provided in the form of the bodywork component.

In the context of the present disclosure, a method for producing a bodywork component as described above is additionally proposed. The method comprises the following steps:
providing a semifinished product as described above,
impregnating the semifinished product, and
processing the impregnated semifinished product to the bodywork component.

The impregnating may be understood as the addition of a bonding means to the semifinished product for the substance-to-substance bonding of the base element or of the semifinished base element to the transmission element or semifinished transmission element. As part of the processing, the impregnated semifinished product may, over a predefined time, be subjected to a predefined pressure and/or exposed to a predefined temperature and/or to a predefined temperature profile. Additionally, the impregnated semifinished product may be shaped or reformed during the processing.

Further measures which improve the disclosure are apparent from the description below of various exemplary embodiments of the disclosure, which are represented schematically in the figures. All of the features and/or advantages evident from the claims, the description or the figures, including construction details and spatial arrangements, may be essential to the disclosure both for themselves and in the various combinations, in which:

### BRIEF DESCRIPTION OF THE DRAWINGS

FIG. 1 shows a bodywork component according to the present disclosure;

FIG. 2 shows a vehicle with a bodywork component of the disclosure;

FIG. 3 shows a semifinished product for producing a bodywork component of the disclosure;

FIG. 4 shows a semifinished product of the disclosure as a roll product according to the disclosure;

FIG. 5 shows a semifinished product cut to shape from the roll product shown in FIG. 4, according to the disclosure;

FIG. 6 shows a semifinished product cut to shape from the roll product shown in FIG. 4;

FIG. 7 shows a semifinished product of the disclosure as a roll product according to the disclosure;

FIG. 8 shows a semifinished product cut to shape from the roll product shown in FIG. 7;

FIGS. 9 to 12 show a method for producing a bodywork component of the disclosure; and

FIG. 13 shows a vehicle with a further bodywork component of the disclosure.

### DETAILED DESCRIPTION

Elements having the same function and mode of action are provided in the figures in each case with the same reference signs.

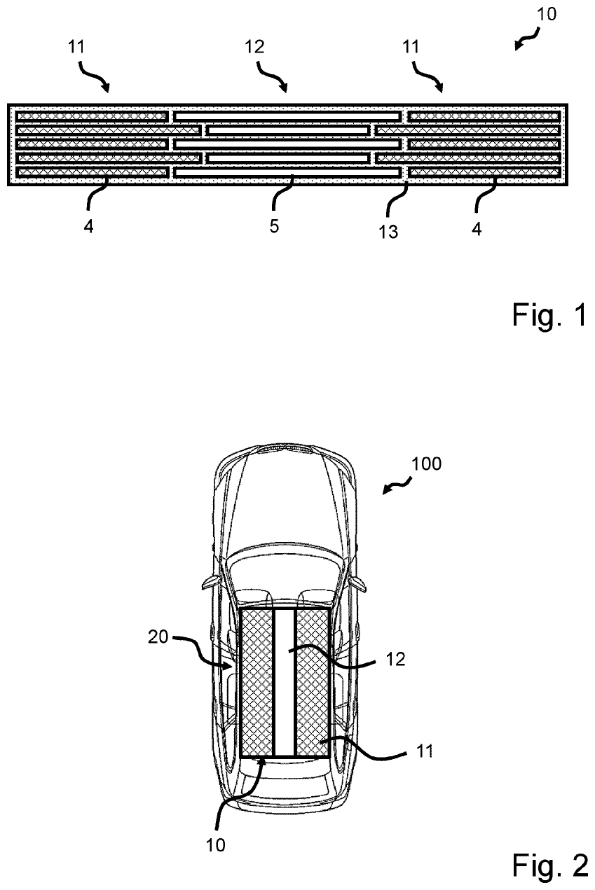

FIG. 1 shows a bodywork component 10 for a vehicle 100. The bodywork component 10 comprises a base element 11 of carbon fiber-reinforced plastic with base fibers 4 in the form of carbon fibers. The base element 11 may accordingly be understood as a CRP base element 11. The bodywork component 10 further comprises a transmission element 12 of glass fiber-reinforced plastic with transmission fibers 5 in the form of glass fibers, where the transmission fibers 5 or glass fibers, to enable radio signal communication through the transmission element 12, have a higher radio signal transmissibility than the base fibers 4 or carbon fibers. The bodywork component 10 shown in FIG. 1 comprises a bonding means 13 by which the base element 11 and the transmission element 12 are in a substance-to-substance bond with one another. The bonding means 13 is designed in the form of a plastics matrix or corresponding resin. As is also evident in FIG. 1, the transmission element 12 extends over the entire bodywork component thickness or approximately over the entire bodywork component thickness. Only the bonding means 13 extends slightly further, negligibly, and shown to an exaggerated extent in the figures for greater ease of representation.

FIG. 2 shows a vehicle 100 having a bodywork component 10 according to FIG. 1. More precisely, the vehicle roof 20 of the vehicle 100 comprises the bodywork component 10 shown in FIG. 1. In the case of this bodywork component 10, the base element 11 and the transmission element 12 each extend over the entire bodywork component length. The transmission element volume in this case is around 30% of the base element volume. Moreover, the transmission element volume is around 20% of the total volume of the bodywork component.

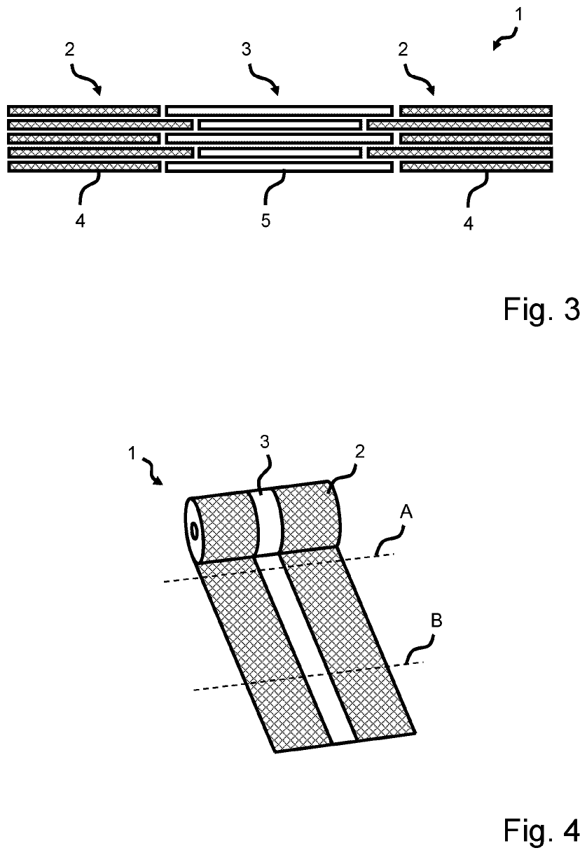

Represented in FIG. 3 is a semifinished product 1 for producing a bodywork component 10 as described above. The semifinished product 1 comprises a semifinished base element 2 with base fibers 4 in the form of carbon fibers, and a semifinished transmission element 3 with transmission fibers 5 in the form of glass fibers. The base fibers 4 and the transmission fibers 5 are each provided in woven form. Moreover, base fibers 4 are partially woven with transmission fibers 5. In other words, the base fibers 4 and the transmission fibers 5 are bonded form-fittingly and force-fittingly to one another. The glass fibers have a higher radio signal transmissibility than the carbon fibers.

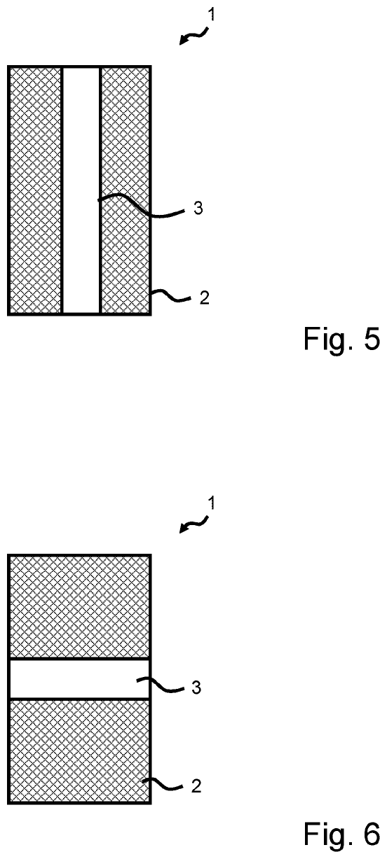

FIG. 4 shows roll product of a semifinished product 1 represented in FIG. 3, from which semifinished product 1 can be cut off according to the cutting line A and the cutting line B. FIG. 5 shows a semifinished product 1 which has been separated according to cutting line A from FIG. 4. In this semifinished product 1, the semifinished base element 2 and the semifinished transmission element 3 each extend over the entire length of the semifinished product. Furthermore, a web of the semifinished transmission element 3 extends between two webs of the semifinished base element 2. FIG. 6 shows a semifinished product 1 which has been separated according to cutting line B from FIG. 4. In this semifinished product 1, the semifinished base element 2 and the semifinished transmission element 3 each extend over the entire width of the semifinished product. Here as well, a web of the semifinished transmission product 3 extends between two webs of the semifinished base element 2. The webs of semifinished product each extend over the entire or approximately over the entire semifinished product thickness of the semifinished product 1.

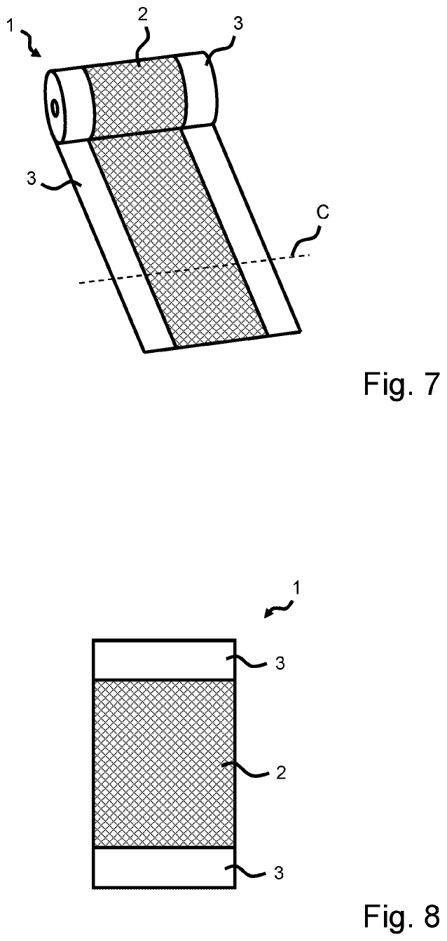

FIG. 7 shows roll product of a semifinished product 1 according to a further embodiment, from which semifinished product 1 can be cut off according to cutting line C. FIG. 8 shows a semifinished product 1 which has been separated according to cutting line C from FIG. 7. In this semifinished product 1, the semifinished base element 2 and the semifinished transmission element 3 each extend over the entire width of the semifinished product. Furthermore, a web of the semifinished base element 2 extends between two webs of the semifinished transmission element 3. The webs of semifinished product each extend over the entire or approximately over the entire semifinished product thickness of the semifinished product 1.

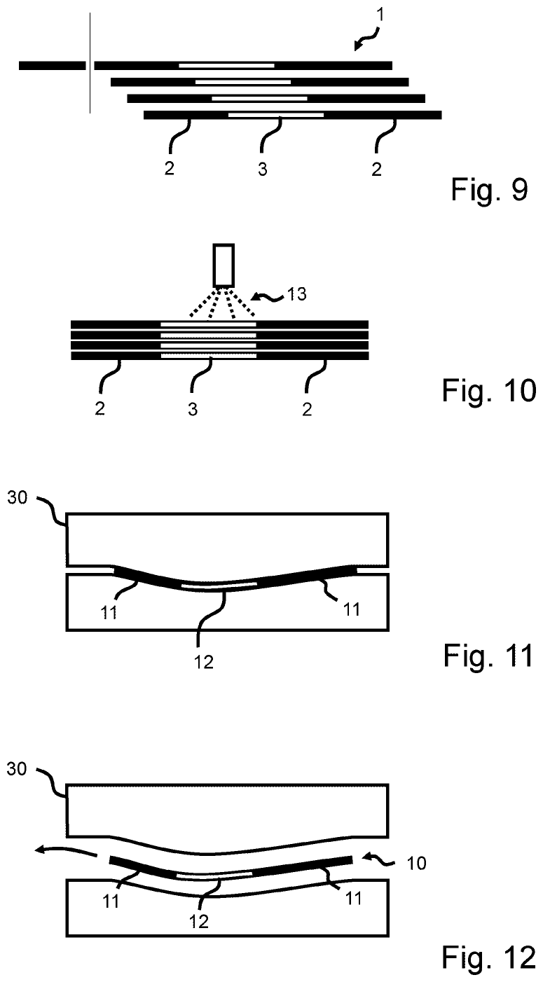

With reference to FIGS. 9 to 12, a method for producing a bodywork component 10 in an illustrative wet compression molding operation is subsequently described. For this operation, first a semifinished product 1 as described above is provided. A choice has been made not to show a detailed representation of how the base fibers 4 and the transmission fibers 5 are interwoven or braided with one another in an initial production process. This may be carried out, for example, in a direct fiber laying process in which tapes of spread roving are laid. As shown in FIG. 9, the semifinished textile product is first cut to the desired length. Subsequently, a plurality of semifinished product layers, as shown in FIG. 10, are placed one atop another and impregnated with a plastics matrix. After a resting phase, the impregnated component, as shown in FIG. 11, is placed into a compression mold 30, where it is brought into the desired shape and also cured over a predefined time and with a predefined pressure. As soon as the component has the desired shape and has sufficiently cured, the compression mold 30, as shown in FIG. 12, is opened and the completed bodywork component can be removed.

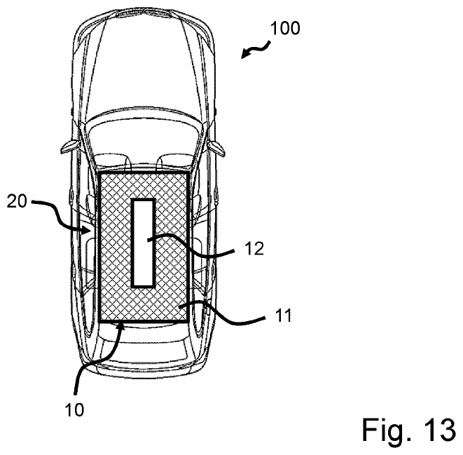

FIG. 13 shows a vehicle 100 having a bodywork component 10 for the vehicle roof, where the base element 11 extends in the form of a frame around the transmission element 12, or the transmission element 12 is designed in window form or in the form of a signal transmission window in the base element 11.

The disclosure admits further design principles in addition to the embodiments represented. In other words, the disclosure is not to be considered to be limited to the exemplary embodiments elucidated with reference to the figures.

### LIST OF REFERENCE SIGNS

1 Semifinished product
2 Semifinished base element
3 Semifinished transmission element
4 Base fibers
5 Transmission fibers
10 Bodywork component
11 Base element
12 Transmission element
13 Bonding means
20 Vehicle roof
30 Compression mold
100 Vehicle
A Cutting line
B Cutting line
C Cutting line

1.-15. (canceled)

16. A bodywork component for a vehicle, comprising:
a base element of fiber-reinforced plastic with base fibers; and
a transmission element of fiber-reinforced plastic with transmission fibers, where the transmission fibers are configured to enable radio signal communication through the transmission element, and have a higher radio signal transmissibility than the base fibers.

17. The bodywork component according to claim 16, wherein the base element consists of carbon fiber-reinforced plastic and/or the base fibers are carbon fibers.

18. The bodywork component according to claim 17, wherein the transmission element consists of glass fiber-reinforced plastic, of aramid fiber-reinforced plastic and/or of basalt fiber-reinforced plastic and/or the transmission fibers are glass fibers, aramid fibers and/or basalt fibers.

19. The bodywork component according to claim 18, wherein the base element and the transmission element are in a substance-to-substance bond with one another.

20. The bodywork component according to claim, 19 wherein the base element extends over the entire bodywork component length or over the entire bodywork component width of the bodywork component and/or the transmission element extends over the entire bodywork component length or over the entire bodywork component width of the bodywork component.

21. The bodywork component according to claim 20, further comprising a bodywork component thickness, a bodywork component length and a bodywork component width, wherein the transmission element extends over the entire bodywork component thickness or over the entire bodywork component thickness.

22. The bodywork component according to claim 21, wherein the base element has a base element volume and the transmission element has a transmission element volume, where the transmission element volume is in a range between 10% and 80% of the base element volume.

23. The bodywork component according to claim 22, wherein the bodywork component has a total volume and the transmission element has a transmission element volume, where the transmission element volume is in a range between 3% and 30% of the total volume.

24. The bodywork component according to claim 22, wherein the bodywork component is a vehicle roof or is configured and designed for producing a vehicle roof.

25. A semifinished product for producing a bodywork component according to claim 24, comprising a semifinished base element with base fibers and a semifinished transmission element with transmission fibers, where the transmission fibers, to enable radio signal communication through the transmission fibers, have a higher radio signal transmissibility than the base fibers.

26. The semifinished product according to claim 25, wherein the base fibers and the transmission fibers are bonded form-fittingly and/or force-fittingly to one another.

27. The semifinished product according to claim 26, wherein the semifinished product is provided as a roll product.

28. A vehicle having a bodywork component according to claim 24.

29. The vehicle according to claim 28, wherein a vehicle roof which comprises the bodywork component.

30. A method for producing a bodywork component, comprising the steps of:
providing a semifinished product according to claim 27;
impregnating the semifinished product; and
processing the impregnated semifinished product to the bodywork component.
